(19) United States
(12) Patent Application Publication
(10) Pub. No.: US 2007/0244289 A1
(43) Pub. Date: Oct. 18, 2007

(54) METHOD OF MAKING URETHANE BASED FLUORINATED MONOMERS

(75) Inventors: Frans A. Audenaert, Kaprijke (BE); Bernd Kuehneweg, Duesseldorf (DE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/279,653

(22) Filed: Apr. 13, 2006

(51) Int. Cl. C08G 18/00

(52) U.S. Cl. 528/44

(57) ABSTRACT

Method of preparing urethane based fluorinated monomers comprising (i) reacting a fluorinated alcohol and an isocyanate functional non-fluorinated monomer or (ii) reacting in one or two steps a fluorinated alcohol, a polyisocyanate and an isocyanate reactive non-fluorinated monomer, wherein reactions (i) and (ii) are carried out in the presence of one or more reactive diluents, the reactive diluents having an ethylenically unsaturated group and being free of isocyanate reactive groups. The method does not require an inert organic solvent as a reaction medium, thus excluding volatile organic compounds (VOC's). The resulting compositions can be readily and conveniently used to prepare radiation curable coating compositions without the need to remove organic solvent from the composition.

### FIELD

The invention provides a method of preparing urethane based fluorinated monomers. In particular, the invention relates to a method of preparing such monomers in the presence of a reactive diluent.

### BACKGROUND

Fluorinated urethane monomers are typically used as intermediates in the synthesis of fluorinated urethane containing polymers that may find application as repellent and stain resistant treating agents on various substrates. For example, the synthesis of perfluoroalkyl type urethane acrylate monomers has been disclosed in U.S. Pat. No. 4,778,915 (Lina et al.), U.S. Pat. No. 5,216,097 (Allewaert et al.), U.S. Pat. No. 4,612,356 (Falk) and U.S. Pat. No. 4,920,190 (Lina et al.). The perfluoroalkyl type urethane acrylate monomers are prepared in an organic solvent. The synthesis of perfluoropolyether based urethane acrylate monomers in fluorinated solvents for example is disclosed in Macromol. Chem. Phys. 198, 1893-1907 (1997).

As shown above, fluorinated urethane based monomers are typically prepared in an organic solvent or a fluorinated solvent since the fluorinated urethane based monomers generally have a very high viscosity or are solid at room temperature. As a result, solventless preparation is generally not feasible, particularly not on an industrial scale where a high viscosity of the reaction product may pose safety risks as a result of unequal distribution of heat in the reaction medium or may result in large fluctuations in quality of the resulting product.

Only in particular specific circumstances can fluorochemical urethane based monomers or oligomers be prepared in the absence of a solvent. For example, U.S. Pat. No. 6,391,459 discloses a radiation curable composition comprising a fluorinated urethane oligomer and a reactive diluent fluorinated monomer. However, such neat reactions are possible only under a limited number of circumstances where the reaction product has sufficient solubility in the reactants.

Nevertheless, the presence of organic solvents in compositions (even small amounts) poses health, safety and environmental concerns and therefore, in recent years, increased pressure is raised for the elimination of undesirable volatile organic compounds (VOCs) in the production of fluorochemical monomers, intermediates and final products such as coatings. Moreover, when a solvent is used in the preparation of the fluorochemical urethane based monomer, it will generally be necessary to remove the solvent when preparing coating compositions based on such monomers. Accordingly this means additional efforts and an increase in cost of the coating composition.

Accordingly, there is a continued need to find a convenient and environmental friendly method for the synthesis of fluorochemical urethane based monomers. In particular, it is desirable to provide a method that eliminates the use of low volatile organic compounds. The method should be economically feasible and applicable for a wide variety of desired fluorinated urethane based monomers.

### BRIEF SUMMARY OF INVENTION

The invention provides a method of preparing urethane based fluorinated monomers comprising (i) reacting a fluorinated alcohol and an isocyanate functional non-fluorinated monomer or (ii) reacting in one or two steps a fluorinated alcohol, a polyisocyanate and an isocyanate reactive non-fluorinated monomer reactions (i) and (ii) are carried out in the presence of one or more reactive diluents, the reactive diluents having an ethylenically unsaturated group and being free of isocyanate reactive groups.

The invention provides a method of preparing urethane based fluorinated monomers that do not require an inert organic solvent as a reaction medium, thus excluding volatile organic compounds (VOC's). Further, the resulting composition can be readily and conveniently used to prepare radiation curable coating compositions without the need to remove organic solvent from the composition.

Thus, in a particular aspect, the invention provides a method of preparing urethane based fluorinated monomers as defined above, wherein said reactions can be carried out in absence of a solvent or substantially in absence of a solvent. With the term “substantially in absence of a solvent” is meant that less than 5% by weight, preferably less than 1% by weight of a solvent based on the total weight of the reaction mixture. By ‘organic solvent’ is meant a generally liquid compound that is capable of dissolving the reactants and/or reaction product and that is inert in the sense that it does not participate in the reaction and further is not a reactive diluent.

### DETAILED DESCRIPTION OF ILLUSTRATIVE EMBODIMENTS

The fluorinated alcohol for use in connection with the method is typically a monofunctional alcohol or polyol that is partially fluorinated or fully fluorinated. Generally the fluorinated alcohol will contain at least a perfluorinated moiety. Suitable fluorinated alcohols include those selected from monofunctional fluorinated alkanols or diol having between 3 and 12 carbon atoms, perfluoropolyether compounds having one or more perfluorinated polyether groups and one or more hydroxyl groups or an oligomeric fluorinated alcohol or diol. Mixtures of fluorinated alcohols are contemplated for use as well.

In one embodiment, the fluorinated alcohol is a monofunctional alkanol or alkanediol that can be represented by the formula I:
PF¹-Q¹-(OH)ₐ (I)
wherein PF¹ represents a perfluorinated aliphatic group, Q¹ is an organic di- or trivalent linking group, and a is 1 or 2, preferably a is 1.

The perfluorinated aliphatic group PF¹ is a perfluorinated, stable, inert, preferably saturated, non-polar, monovalent aliphatic radical containing 3 to 12 carbon atoms. It can be straight chain or branched chain. Especially suitable fluorinated alcohols are those of which the PF¹-group has 4 to 6 carbon atoms and is of the formula C₄F₉— or C₆F₁₃—.

Linking group Q¹ is generally non-fluorinated or partially fluorinated and may contain from 1 to about 20 carbon atoms. Q¹ may include aromatic or aliphatic groups and can optionally contain oxygen, nitrogen, or sulfur-containing groups or a combination thereof. Examples of suitable linking groups Q¹ include straight chain, branched chain or cyclic alkylene, arylene, aralkylene, sulfonyl, sulfoxy, sulfonamido, carbonamido, carbonyloxy, urethanylene, ureylene, and combinations thereof such as sulfonamidoalkylene.

Specific examples of mono or di-functional fluorinated alkanols include:
CF₃CF₂CF₂CF₂CH₂CH₂OH, CF₃CF₂CF₂CF₂CF₂CF₂CH₂CH₂OH,
CF₃(CF₂)₃ SO₂N(CH₃)CH₂CH₂OH, CF₃(CF₂)₃ SO₂N(CH₃)CH₂CH(OH)CH₂OH,
CF₃(CF₂)₃SO₂N(C₂H₅)CH₂CH₂OH, CF₃(CF₂)₃SO₂N(C₂H₅)CH₂CH(OH)CH₂OH,
CF₃(CF₂)₃SO₂N(CH₃)CH₂CH(CH₃)OH, (CF₃)₂CFCF₂SO₂N(CH₃)CH₂CH₂OH

In an alternative embodiment of the invention, the fluorinated alcohol may be a perfluoropolyether compound having one or more perfluorinated polyether groups and one or more hydroxyl groups. By the term “perfluoropolyether compound” is meant a compound having a fluorinated polyether group that consists of carbon and fluorine and that contains at least two ether linkages.

In one embodiment the perfluoropolyether compound can be represented by the formula II:
PF²-Q²-(OH)_{b} (II)
wherein PF² represents a perfluoropolyether group, Q² represents a divalent or trivalent generally non-fluorinated or partially fluorinated organic linking group, b is 1 or 2 and preferably b is 1. Examples of linking groups Q² include organic groups that comprise aromatic or aliphatic groups that may be interrupted by O, N, or S and that may be substituted, alkylene groups, oxy groups, thio groups, urethane groups, carboxy groups, carbonyl groups, amido groups, oxyalkylene groups, thioalkylene groups, carboxyalkylene and/or amidoalkylene groups.

In one particular embodiment, the perfluorinated polyether group PF² of formula (II) is a monovalent perfluoropolyether moiety composed of groups according to formula III:
F(R_{fc}O)ₓC_{d}F_{2d}— (III)
wherein each R_{fc} independently represents a perfluorinated alkylene group, each x independently represents an integer greater than or equal to 3, and wherein d is an integer from 1 to 6. The perfluoroalkylene group R_{fc} may be linear or branched and may comprise from 1 to 10 carbon atoms, particularly suitable from 1 to 6 carbon atoms. Examples of perfluorinated alkyleneoxy groups —R_{fc}O— include: —CF₂CF₂O—, —CF(CF₃)CF₂O—, —CF₂CF(CF₃)O—, —CF₂CF₂CF₂O—, —CF₂O—, —CF(CF₃)O—, —CF₂CF₂CF₂CF₂—O—.

The perfluorinated polyether group may be comprised of the same perfluorinated alkylene oxy units or of a mixture of different perfluorinated alkylene oxy units. When the perfluorinated polyether group is composed of different perfluorinated alkylene oxy units, they can be present in a random configuration, alternating configuration or they can be present as blocks. Typical examples of perfluorinated polyalkylene oxy groups include:
—[CF₂CF₂O]ᵣ—; —[CF(CF₃)CF₂O]ₛ—; —[CF₂CF₂O]ᵢ[CF₂O]ⱼ— and —[CF₂CF₂O]ₗ—[CF(CF₃)CF₂O]ₖ—; wherein r is an integer of 5 to 25, s is an integer of 3 to 25 and i, j, l and k each are integers of 3 to 25.

A particularly suitable perfluorinated polyether group that corresponds to formula (III) is:
F(CF(CF₃)CF₂O)_{g}CF(CF₃)—
wherein g is at least 3. Perfluorinated polyether groups of the above formula can conveniently be derived from the oligomerization of hexafluoropropyleneoxide (HFPO). In a particular suitable embodiment, g is an integer of 3 to 25, and the corresponding perfluorinated polyether group has a molecular weight of at least 750 g/mol.

Suitable examples of perfluoropolyether compounds according to formula (II) include:
F(CF(CF₃)CF₂O)_{g}CF(CF₃)—CONR^{c}—CH₂CHOHCH₂OH wherein R^{c} is hydrogen or an alkyl group of, for example, 1 to 4 carbon atoms;
F(CF(CF₃)CF₂O)_{g}CF(CF₃)—CONH1,4-dihydroxyphenyl;
F(CF(CF₃)CF₂O)_{g}CF(CF₃)—CH₂OCH₂CHOHCH₂OH;
F(CF(CF₃)CF₂O)_{g}CF(CF₃)—COOCH₂CHOHCH₂OH;
F(CF(CF₃)CF₂O)_{g}CF(CF₃)—CONR^{d}—(CH₂)ᵥOH;
F(CF(CF₃)CF₂O)_{g}CF(CF₃)—CONR_{d}((CH₂)ᵥ—O)_{w}—H; and
F(CF(CF₃)CF₂O)_{g}CF(CF₃)—CONHCH₂CH₂CH₂N(CH₂CH₂OH)₂
where R^{d} is hydrogen or an alkyl group such as methyl, ethyl, propyl, butyl, or hexyl, and v is 2, 3, 4, 6, 8, 10 or 11, w is 1 to 4; in all examples g is at least 3. Particularly suitable example includes F(CF(CF₃)CF₂O)_{g}CF(CF₃)—CONR^{d}—(CH₂)ᵥOH where R^{d} is hydrogen, v is 2, and g is at least 3.

In a further embodiment of the present invention, the fluorinated alcohol can be an oligomeric fluorinated alcohol that can be represented by to formula:
M^{f}ₘM^{h}ₙQ³(OH)_{c}
wherein c is 1 or 2, preferably 1, M^{f}ₘM^{h}ₙ represents a fluorinated oligomer comprising m units derived from a fluorinated monomer and n units derived from a non-fluorinated monomer, e.g., a hydrocarbon monomer, m represents a value of 2 to 40, n is 0 to 20 and -Q³-(OH)_{c} together represents the organic residue obtained by removing a hydrogen atom from a chain transfer agent that is functionalized with one or two hydroxy groups. The value of m in the oligomeric fluorinated alcohol is from 2 to 40, more suitably from 2 to 20, and particularly suitably from 3 to 15. Fluorinated oligomers derived from two or more different fluorinated monomers and optional non-fluorinated monomers are also suitable.

In the above formula, Q³ typically represents an organic residue according to the following formula:
—S—R—
wherein R represents an organic divalent linking group that is preferably selected from the group consisting of linear or branched alkylenes (preferably having about 2 to 6 carbon atoms), cyclic alkylenes, arylenes and aralkylenes.

The oligomeric fluorinated alcohol can be prepared by free-radical oligomerization of fluorinated and non-fluorinated monomers in the presence of hydroxy functionalized chain transfer agents. The aliphatic backbone of the oligomeric fluorinated alcohol comprises a sufficient number of polymerized units to render the portion oligomeric, e.g., such that the sum of n and m in the above formula is from 2 to 60, e.g., from 4 to 30.

In a particular embodiment, the fluorinated monomer is typically an ester of an α,β-ethylenically unsaturated carboxylic acid and contains a fluoroaliphatic group. The fluorinated monomer can be represented by the general formula:
PF³—X—OC(O)—C(R)═CH₂
wherein PF³ represents a perfluorinated aliphatic group having 3 to 12 carbon atoms, X is an organic divalent linking group, and R represents hydrogen, fluor or a lower alkyl group having 1 to 4 carbon atoms.

The perfluorinated aliphatic group PF³ is a perfluorinated, stable, inert, preferably saturated, non-polar, monovalent aliphatic radical containing 3 to 6 carbon atoms. It can be straight chain or branched chain. Especially suitable fluorinated monomers are those of which the PF³-group is of the formula C₄F₉— or C₆F₁₃—.

The linking group X links the perfluorinated aliphatic group PF³ to the free radical polymerizable group. Linking group X is generally non-fluorinated and preferably contains from 1 to about 20 carbon atoms. X can optionally contain oxygen, nitrogen, or sulfur-containing groups or a combination thereof, and X is free of functional groups that substantially interfere with free-radical polymerization (e.g., polymerizable olefinic double bonds, thiols, and other such functionality known to those skilled in the art). Examples of suitable linking groups X include straight chain, branched chain or cyclic alkylene, arylene, aralkylene, sulfonyl, sulfoxy, sulfonamido, carbonamido, carbonyloxy, urethanylene, ureylene, and combinations thereof such as sulfonamidoalkylene.

Specific examples of fluorinated monomers include:
CF₃CF₂CF₂CF₂CH₂CH₂OCOCR¹═CH₂; CF₃(CF₂)₅CH₂CH₂OCOCR¹═CH₂;
CF₃(CF₂)₃CH₂OCOCR¹═CH₂; CF₃(CF₂)₃SO₂N(CH₃)CH₂CH₂OCOCR¹═CH₂;
CF₃(CF₂)₃ SO₂N(C₂H₅)CH₂CH₂OCOCR¹═CH₂;
CF₃(CF₂)₃ SO₂N(CH₃)CH₂CH(CH₃)OCOCR¹═CH₂; and
(CF₃)₂CFCF₂SO₂N(CH₃)CH₂CH₂OCOCR¹═CH₂
wherein R¹ is hydrogen or methyl

In one embodiment of the invention the non-fluorinated monomer is typically a monomer consisting of a polymerizable group and a hydrocarbon moiety. Hydrocarbon group containing monomers are well known and generally commercially available. Useful hydrocarbon containing monomers include those according to formula:
R^{h}-Q⁶ₛ-E (VI)
wherein R^{h} represents a hydrocarbon group or H, Q⁶ is a divalent linking group, s is 0 or 1, and E is a free radical polymerizable group. Examples of linking groups Q⁶ include oxy, carbonyl, carbonyloxy, carbonamido, sulphonamido, oxyalkylene and poly(oxyalkylene).

Examples of non-fluorinated monomers from which the units M^{h} can be derived include general classes of ethylenic compounds capable of free-radical polymerization, such as, for example, allyl esters such as allyl acetate and allyl heptanoate; alkyl vinyl ethers or alkyl allyl ethers such as cetyl vinyl ether, dodecylvinyl ether, 2-chloroethylvinyl ether, ethylvinyl ether; unsaturated acids such as acrylic acid, methacrylic acid, alpha-chloro acrylic acid, crotonic acid, maleic acid, fumaric acid, itaconic acid and their anhydrides and their esters such as vinyl, allyl, methyl, butyl, isobutyl, hexyl, heptyl, 2-ethylhexyl, cyclohexyl, lauryl, stearyl, isobornyl or alkoxy ethyl acrylates and methacrylates; alpha-beta unsaturated nitriles such as acrylonitrile, methacrylonitrile, 2-chloroacrylonitrile, 2-cyanoethyl acrylate, alkyl cyanoacrylates; alpha,beta-unsaturated carboxylic acid derivatives such as allyl alcohol, allyl glycolate, acrylamide, methacrylamide, n-diisopropyl acrylamide, diacetoneacrylamide, N,N-diethylaminoethylmethacrylate, N-t-butylamino ethyl methacrylate; styrene and its derivatives such as vinyltoluene, alpha-methylstyrene, alpha-cyanomethyl styrene; lower olefinic hydrocarbons which can contain halogen such as ethylene, propylene, isobutene, 3 -chloro-1-isobutene, butadiene, isoprene, chloro and dichlorobutadiene and 2,5 -dimethyl-1,5-hexadiene, and allyl or vinyl halides such as vinyl and vinylidene chloride. Preferred non-fluorinated monomers include hydrocarbon group containing monomers such as those selected from octadecylmethacrylate, laurylmethacrylate, butylacrylate, N-methylol acrylamide, isobutylmethacrylate, ethylhexyl acrylate and ethylhexyl methacrylate; and vinylcloride and vinylidene chloride.

Examples of hydroxyl functionalized chain transfer agents include those selected from 2-mercaptoethanol, 3-mercapto-2-butanol, 3-mercapto-2-propanol, 3-mercapto-1-propanol and 3-mercapto-1,2-propanediol. A single compound or a mixture of different chain transfer agents may be used. A particular suitable chain transfer agent is 2-mercaptoethanol.

In order to prepare the oligomeric fluorinated alcohol, a free radical initiator is normally present. Such free radical initiators are known in the art and include azo compounds, such as azobisisobutyronitrile (AIBN) and azobis(2-cyanovaleric acid) and the like, hydroperoxides such as cumene, t-butyl, and t-amyl hydroperoxide, dialkyl peroxides such as di-t-butyl and dicumylperoxide, peroxyesters such as t-butylperbenzoate and di-t-butylperoxy phtalate, diacylperoxides such as benzoyl peroxide and lauroyl peroxide.

In one embodiment of the method, the fluorinated alcohol is reacted with an isocyanate functional non-fluorinated monomer. Isocyanate functional non-fluorinated monomers for use in preparing fluorinated urethane based monomers include in particular isocyanate functional acrylate or methacrylate non-fluorinated monomers. Suitable isocyanate functional acrylate or methacrylate non-fluorinated monomers can be selected from the group of 2-isocyanato ethylmethacrylate (IEM), m-isopropenyl-a,a-dimethyl benzyl isocyanate (m-TMI) and methacryloyl isocyanate.

In another embodiment of the method, the fluorinated urethane based monomer is prepared by reacting an isocyanate reactive non-fluorinated monomer, a polyisocyanate and the fluorinated alcohol.

Polyisocyanates that may be used include those that can be selected from one or more aliphatic isocyanates having 2, 3, or 4 isocyanate groups, one or more aromatic isocyanates having 2, 3, or 4 isocyanate groups and mixtures thereof. Examples of aliphatic diisocyanates include hexamethylenediisocyanate, 2,2,4-trimethyl-1,6-hexamethylenediisocyanate, and 1,2-ethylenediisocyanate, dicyclohexylmethane-4,4′-diisocyanate and 3-isocyanatomethyl-3,5,5-trimethylcyclohexylisocyanate (isophorone diisocyanate IPDI). Examples of aliphatic triisocyanates include 1,3,6-hexamethylenetriisocyanate, cyclic trimer of hexamethylenediisocyanate and cyclic trimer of isophorone diisocyanate (isocyanurates). Examples of aromatic diisocyanates include 4,4′-methylenediphenylenediisocyanate, 4,6-di-(trifluoromethyl)-1,3-benzene diisocyanate, 2,4-toluenediisocyanate, 2,6-toluene diisocyanate, o, m, and p-xylylene diisocyanate, 4,4′-diisocyanatodiphenylether, 3,3′-dichloro-4,4′-diisocyanatodiphenylmethane, 4,5′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate. Exampels of aromatic triisocyanates include polymethylenepolyphenylisocyanate (PAPI).

Also useful are isocyanates containing internal isocyanate-derived moieties such as biuret-containing triisocyanates, such as DESMODUR™ N100 or TOLONATE HDB, commercially available from Bayer or Rhodia respectively; isocyanurate-containing tri-isocyanates, such as IPDI-1890, commercially available from Huls AG; azetedinedione-containing diisocyanates such as DESMODUR™ TT, commercially available from Bayer. Also, other commercially available di- or tri-isocyanates such as DESMODUR™ L and DESMODUR™ W, tri-(4-isocyanatophenyl)-methane (DESMODUR™ R) (all available from Bayer) and DDI 1410 (available from Henkel) are suitable.

Isocyanate reactive non-fluorinated monomers include in particular monomers having a hydroxyl group including for example hydroxy functional vinyl ethers, acrylamides and isocyanate reactive acrylates and methacrylates. Isocyanate reactive acrylate or methacrylate non-fluorinated monomers that may be used include those that can be represented by the following formula:
T-Q⁴-(OC(O)C(R₂)═CH₂)ₜ,
wherein T represents an isocyanate reactive group, including OH or NR′H where R′ is H or a lower alkyl group of 1 to 4 carbon atoms, Q⁴ represents an organic linking group having a valence of t+1; R₂ is a lower alkyl with 1 to 4 C atoms or H, and t is a value from 1 to 6.

Linking group Q⁴ is independently selected from the group consisting of an alkylene, an arylene, an aralkylene, an alkarylene, a straight or branched chain or cyclic group containing connecting group optionally containing heteroatoms such as O, N, and S and optionally a heteroatom-containing functional group such as carbonyl or sulfonyl, and combinations thereof.

Particularly suitable examples of isocyanate reactive acrylate or methacrylate non-fluorinated monomers include hydroxyethyl(meth)acrylate, 1,3-glycerol dimethacrylate, hydroxypropyl(meth)acrylate, butanediol monoacrylate, pentaerythritol triacrylate, commercially available as SR444 from Sartomer and dipentaerythritol pentaacrylate, commercially available as SR399 from Sartomer. Further suitable monomers include monomers comprising (poly)oxyalkylene groups including (meth)acrylates of a polyethylene glycol, (meth)acrylates of a block copolymer of ethylene oxide and propylene oxide, and (meth)acrylates of aminoterminated polyethers. Single isocyanate reactive acrylate or methacrylate non-fluorinated monomers can be used or mixtures thereof.

The reactive diluent for use in the method has an ethylenically unsaturated group and is free of isocyanate reactive groups. It has been found that the reactive diluent can be used to solubilise the reactants and the urethane based fluorinated monomers formed during and after the reaction. Accordingly, the reaction can proceed well without resulting in a solid product or in a composition of a too high viscosity. Particular useful diluents are liquid at a temperature of about 20° C. Examples of suitable reactive diluents include monomers having an acrylate or methacrylate group. Examples include methyl methacrylate, ethyl methacrylate n-butyl(meth)acrylate, isobutyl(meth)acrylate, octadecyl(meth)acrylate, lauryl(meth)acrylate, cyclohexyl(meth)acrylate, cyclodecyl(meth)acrylate, isobornyl(meth)acrylate, phenyl(meth)acrylate, phenoxy ethyl acrylate, benzyl(meth)acrylate, adamantyl(meth)acrylate, tolyl(meth)acrylate, 3,3-dimethylbutyl(meth)acrylate, (2,2-dimethyl-1-methyl)propyl(meth)acrylate, cyclopentyl(meth)acrylate, 2-ethylhexyl(meth)acrylate, t-butyl(meth)acrylate, cetyl(meth)acrylate, stearyl(meth)acrylate, behenyl(meth)acrylate, isooctyl(meth)acrylate, n-octyl(meth)acrylate, 4-ethyl-cyclohexyl(meth)acrylate, 2-ethoxyethyl methacrylate, tetrahydropyranyl acrylate and tetrahydrofurfuryl acrylate. Further examples of suitable reactive diluents include di- and poly(meth)acrylates, such as butanedioldiacrylate, hexanedioldiacrylate and trimethylolpropane triacrylate. Further examples of reactive diluents include monomers having one or more vinyl ether groups, such as cetyl vinyl ether, dodecylvinyl ether, ethylvinyl ether. Further examples of reactive diluents include monomers having one or more N-vinyl amides, such as N-vinylcaprolactam, N-vinylformamide. Still further examples of reactive diluents include acrylamides, such as acrylamide, methacrylamide, n-diisopropyl acrylamide, diacetoneacrylamide. Still further examples of reactive diluents include vinylesters, such as vinyl 2-ethylhexanoate and vinyldecanoate. Particularly suitable reactive diluents include methylmethacrylate and butanediol diacrylate.

The reactive diluent is typically used in an amount of at least 10% by weight, suitably at least 25% by weight based on the total weight of the reactive diluent and reactants.

Optional coreactants may be used in the method of the present invention. Suitable examples include non-fluorinated organic compounds that have one, two or more functional groups that are capable of reacting with an isocyanate group. A particularly suitable example includes aminopropyl trimethoxysilane. Further examples of optional coreactants include aliphatic monofunctional alcohols, e.g., mono-alkanols having at least 1, preferably at least 6 carbon atoms and aliphatic monofunctional amines. Further suitable examples optional coreactants include organic compounds that have polyoxyalkylene groups. Preferred polyoxyalkylene groups include those having 1 to 4 carbon atoms such as polyoxyethylene, polyoxypropylene, polyoxytetramethylene and copolymers thereof such as polymers having both oxyethylene and oxypropylene units. The polyoxyalkylene containing organic compound may have one or two functional groups such as hydroxy or amino groups. Examples of polyoxyalkylene containing compounds include polyethyleneglycol, polypropyleneglycol, hydroxy terminated methyl or ethyl ether of a random or block copolymer of ethyleneoxide and propyleneoxide, amino terminated methyl or ethyl ether of polyethyleneoxide, polyethylene glycol, polypropylene glycol, dihydroxy terminated copolymer (including a block copolymer) of ethylene oxide and propylene oxide, a diamino terminated poly(alkylene oxide) such as Jeffamine™ ED and Jeffamine™ EDR-148 or mixtures thereof.

The optional coreactants will typically be used in an amount up to 30% by weight, suitably up to 20% by weight based on the total weight of the reactants.

Typically a catalyst is used in the method of preparing urethane based fluorinated monomers. Suitable catalysts include tin salts such as dibutyltin dilaurate, stannous octanoate, stannous oleate, tin dibutyldi-(2-ethyl hexanoate), tin ethyl hexanoate, stannous chloride and others known in the art. The amount of catalyst present will depend on the particular reaction and reactants used. Generally, suitable catalyst concentrations are from 0.001 to 10 % by weight, particularly suitable between 0.05% and 5% by weight based on the total weight of reactants.

The reaction is preferably carried out under dry conditions. Suitable reaction temperature will depend on the reagents and kind and amount of catalyst used. Generally suitable temperatures are between room temperature and 120° C.

In order to prevent thermal polymerization reactions of the urethane based fluorinated monomers prepared and/or reactive diluents, inhibitors, known in the art are conveniently added. Typical examples include methyl hydroquinone (MEHQ), phenothiazine and 2,6-di t.butyl-4-methyl phenol.

In first embodiment of the invention, the method of preparing urethane based fluorinated monomers comprises reacting a fluorinated alcohol, an isocyanate functional non-fluorinated monomer in the presence of a reactive diluent having an ethylenically unsaturated group and being free of isocyanate reactive groups. The amounts of the reactants are generally chosen such that the equivalent amounts of alcohol groups and isocyanate groups in the reaction mixture are equal or about equal.

A typical example of a urethane based fluorinated monomers prepared according to this method can be represented by formula (IV):
R_{f}-L-(OC(O)NHQOC(O)C(R)═CH₂)ₚ (IV)
R_{f} is a monovalent perfluorinated aliphatic group, a perfluoropolyether moiety or an fluorinated oligomer as defined above for PF¹, PF² or M^{f}ₘM^{h}ₙ respectively; L is a divalent or trivalent linking group as defined for Q¹, Q² and Q³ above, Q is an organic linking group, R is a lower alkyl with 1 to 4 C atoms or H, and p is 1 or 2.

In a second embodiment the method of preparing urethane based fluorinated monomers comprises a one or two step reaction. In one embodiment the method of preparing urethane based fluorinated monomers comprises a one step reaction wherein a mixture of a fluorinated alcohol, a polyisocyanate and an isocyanate reactive non-fluorinated monomer is reacted in a reactive diluent.

In a further embodiment the method of preparing urethane based fluorinated monomers comprises a two step reaction in reactive diluent wherein in a first step, the fluorinated alcohol and the polyisocyanate can be reacted in relative amounts such that a resulting reaction product has one or more free isocyanate groups. In a second step, the free isocyanate groups can be further reacted with the isocyanate reactive non-fluorinated monomer. The optional coreactants can be added in the first or second step of the reaction.

By their method of synthesis, urethane based fluorinated monomers are generally mixtures. If the equivalent amount of isocyanate groups is arbitrarily given a value of 1.0, then the total equivalents of fluorinated alcohol, isocyanate reactive non-fluorinated monomer and optional coreactants can be 1.0 or greater or smaller than 1.0. If it is less than 1.0, a urethane based fluorinated monomer with free isocyanate groups is typically formed. In a particular suitable embodiment, it is 1.0 or greater than 1.0. Typically the equivalent amount of fluorinated alcohol relates to equivalent amount of isocyanate reactive non-fluorinated monomer from 0.95:0.05 to 0.05:0.95. Suitably, the equivalent amount ranges from 0.50:0.50 to 0.05:0.95. Particularly suitable, the equivalent amount ranges from 0.35: 0.65 to 0.10:0.90.

A typical example of urethane based fluorinated monomers, prepared according to the second embodiment, can be represented by formula (V):
Rᵢ—(NHC(O)OQR_{f})ₘ,—(NHC(O)OQ(A)_{y})ₙ (V)
wherein Rᵢ is the residue of a polyisocyanate; R_{f} is a monovalent perfluorinated aliphatic group, a perfluoropolyether moiety or an fluorinated oligomer as defined above for PF¹, PF² or M^{f}ₘM^{h}ₙ respectively; Q is independently a linking group of valency at least 2 and is selected from the group consisting of an alkylene, an arylene, an aralkylene, an alkarylene, a straight or branched chain or cycle-containing linking group optionally containing heteroatoms such as O, N, and S and optionally a heteroatom-containing functional group such as carbonyl or sulfonyl, and combinations thereof, A is a (meth)acryl functional group —OC(O)C(R₂)═CH₂, where R₂ is a lower alkyl of 1 to 4 carbon atoms or H; m is at least 1; n is at least 1; y is 1 to 6, m+n is 2 to 4, and in which each unit referred to by the subscripts m and n is attached to an Rᵢ unit. The maximum of m+n typically corresponds to the number of isocyanate groups present in the polyisocyanate compound from which the residue Rᵢ derives.

The method provides urethane based fluorinated monomers in reactive diluents that can be used in a variety of applications, including thermal and radiation curable coating applications for e.g. hard surface substrates. In a particular embodiment, the composition obtained with the method can be used to formulate a ceramer composition such as for example disclosed in U.S. Pat. No. 6,238,798. Accordingly, to formulate a ceramer composition, the composition resulting from the method of the invention may be combined with further additives including inorganic particles in particular colloidal inorganic particles.

Inorganic oxide particles for use in a ceramer composition are desirably substantially spherical in shape, relatively uniform in size (have a substantially monodisperse size distribution) or a polymodal distribution obtained by blending two or more substantially monodisperse distributions. It is further preferred that the inorganic oxide particles be and remain substantially non-aggregated (substantially discrete), as aggregation can result in precipitation of the inorganic oxide particles or gellation of the ceramer composition, which, in turn, results in a dramatic, undesirable increase in viscosity. As a result of these effects, aggregation of the inorganic oxide particles can reduce both adhesion to a substrate and optical clarity of the ceramer composition.

It is further preferred that the inorganic oxide particles be colloidal in size, i.e., characterized by an average particle diameter of about 1 nanometer to about 200 nanometers, preferably from about 1 nanometer to about 100 nanometers, more preferably from about 2 nanometers to about 75 nanometers. These size ranges facilitate ease of dispersion of the colloidal inorganic oxide particles into the ceramer composition and provide ceramer composites that are smoothly surfaced and optically clear. Average particle size of the colloidal inorganic oxide particles can be measured using transmission electron microscopy to count the number of colloidal inorganic oxide particles of a given diameter.

A wide range of colloidal inorganic oxide particles can be used in the ceramer compositions of the present invention. Representative examples include colloidal silica, colloidal titania, colloidal alumina, colloidal zirconia, colloidal vanadia, colloidal chromia, colloidal iron oxide, colloidal antimony oxide, colloidal tin oxide, and mixtures thereof. The colloidal inorganic oxide particles can comprise essentially a single oxide such as silica, a combination of oxides, such as silica and aluminum oxide, or a core of an oxide of one type (or a core of a material other than a metal oxide) on which is deposited an oxide of another type.

In one preferred embodiment, for example, the colloidal inorganic oxide particles advantageously may comprise a major amount of a first plurality of primary colloidal inorganic oxide particles, e.g., silica, and a minor amount of a second plurality of one or more other colloidal inorganic oxide particles (i.e., “additive oxide(s)”), preferably an aluminum oxide. As used herein, “major amount” means that the colloidal inorganic oxide particles include at least 60% by weight, preferably about 80% by weight, more preferably at least about 95% by weight, most preferably at least about 98% by weight of that component based on the total weight of the particles. “Minor amount” means that the colloidal inorganic oxide particles include up to 40% by weight, preferably up to 20% by weight, more preferably up to 5% by weight, most preferably up to about 2% by weight of that component based on the total weight of the particles.

The optimum amount of additive colloidal inorganic oxide particles to be incorporated into a ceramer composition will depend upon a number of factors including the type(s) of additive colloidal inorganic oxide particle(s) being used, the desired end use of the ceramer composition, and the like. Generally, if too much of the additive colloidal inorganic oxide particles is used, the resultant cured ceramer composite may become more hazy than desired. It is additionally possible that the level of abrasion resistance may also be unduly reduced. As a guideline, particularly preferred ceramer compositions may include about 100 parts by weight of silica, i.e., primary colloidal inorganic oxide particles, and from about 0.01 to about 10, preferably from about 1 to about 2 parts by weight of an oxide other than silica, preferably an aluminum oxide, i.e., additive colloidal inorganic oxide particles.

The colloidal inorganic oxide particles are desirably provided in the form of a sol (e.g., colloidal dispersions of inorganic oxide particles in liquid media), especially aqueous sols of amorphous silica. Unlike other forms in which the colloidal inorganic oxide particles may be supplied (e.g., fumed silica which comprises irregular aggregates of colloidal particles), colloidal inorganic oxide particles supplied in the form of sols tend to be substantially monodisperse in size and shape.

The ceramer composition may further include other optional additives. For example, if desired, the ceramer composition may include solvents, surfactants, antistatic agents, leveling agents, initiators, photosensitizers, stabilizers, absorbers, antioxidants, fillers, fibers, lubricants, pigments, dyes, plasticizers, suspending agents and the like. Also in a particular embodiment, surface treatment agents may be included that can react with the inorganic oxide particles and/or the substrate's surface to which the ceramer composition is to be applied.

Examples of leveling agents include, but are not limited to, alkylene oxide terminated polysiloxanes, such as those available under the trade designation “DOW 57” (a mixture of dimethyl-, methyl-, and (polyethylene oxide acetate-capped) siloxane) from Dow Coming, Midland, Mich.; and fluorochemical surfactants such as those available under the trade designations “FC4430”, and “FC4432”, from Minnesota Mining and Manufacturing Company Co., St. Paul, Minn. Combinations of different leveling agents can be used if desired. Preferably, if a leveling agent is to be included in the ceramer composition, the leveling agent is present in an amount effective to improve the flow and wetting characteristics of the ceramer composition. Generally, the leveling agent will be effective to impart these desired characteristics in amounts of up to about 3% by weight, and more preferably from about 0.01 to about 1%, based on the total weight of the ceramer composition solids.

Examples of suitable free radical initiators that generate a free radical source when exposed to thermal energy include, but are not limited to, peroxides such as benzoyl peroxide, azo compounds, benzophenones, and quinones. Examples of photoinitiators that generate a free radical source when exposed to visible light radiation include, but are not limited to, camphorquinones/alkyl amino benzoate mixtures. Examples of photoinitiators that generate a free radical source when exposed to ultraviolet light include, but are not limited to, organic peroxides, azo compounds, quinones, benzophenones, nitroso compounds, acryl halides, hydrozones, mercapto compounds, pyrylium compounds, triacrylimidazoles, bisimidazoles, chloroalkytriazines, benzoin, benzoin methyl ether, benzoin ethyl ether, benzoin isopropyl ether, benzoin isobutyl ethers and methylbenzoin, diketones such as benzil and diacetyl, phenones such as acetophenone, 2,2,2-tri-bromo-1-phenylethanone, 2,2-diethoxyacetophenone, 2,2-dimethoxy-2-phenylacetophenone, 2,2,2,-tribromo-1 (2-nitrophenyl)ethanone, benzophenone, 4,4-bis(dimethyamino)benzophenone, and acyl phosphates. Examples of commercially available ultraviolet photoinitiators include those available under the trade designations “IRGACURE 184” (1-hydroxycyclohexyl phenyl ketone), “IRGACURE 361” and “DAROCUR 1173” (2-hydroxy-2-methyl-1-phenyl-propan-1-one) from Ciba-Geigy. Typically, if used, an amount of an initiator is included in the ceramer composition to effect the desired level and rate of cure. Preferably, the initiator is used in an amount of from about 0.1 to about 10%, and more preferably from about 2 to about 4% by weight, based on the total weight of the ceramer composition without solvent. It should be understood that combinations of different initiators can be used if desired.

In addition to the initiator, a ceramer composition can include a photosensitizer The photosensitizer aids in the formation of free radicals that initiate curing of the curable binder precursors, especially in an air atmosphere. Suitable photosensitizers include, but are not limited to, aromatic ketones and tertiary amines. Suitable aromatic ketones include, but are not limited to, benzophenone, acetophenone, benzil, benzaldehyde, and o-chlorobenzaldehyde, xanthone, thioxanthone, 9,10-anthraquinone, and many other aromatic ketones. Suitable tertiary amines include, but are not limited to, methyldiethanolamine, ethyldiethanolamine, triethanolamine, phenylmethyl-ethanolamine, dimethylaminoethylbenzoate, and the like. Typically, if used, an amount of photosensitizer is included in the ceramer compositions to effect the desired level and rate of cure. Preferably, the amount of photosensitizer used in ceramer compositions is about 0.01 to about 10%, more preferably about 0.05 to about 5%, and most preferably about 0.25 to about 3% by weight, based on the total weight of the ceramer composition solids. It should be understood that combinations of different photosensitizers can be used if desired.

Both ultraviolet stabilizers and ultraviolet absorbers can improve the weatherability and reduce the time-induced discoloration of the ceramer composition. An example of an ultraviolet absorber suitable for use in the ceramer composition of the present invention is that commercially available under the trade designation “TINUVIN 1130” (hydroxyphenyl benzotriazole) and an example of an hindered amine light stabilizer suitable for use in the ceramer composition of the present invention is that commercially available under the trade designation “TINUVIN 292” (bis(1,2,2,6,6-pentamethyl-4-piperidinyl)sebacate), both of which are available from Ciba-Geigy. The ceramer composition can include an amount of a stabilizer, an absorber, or a combination thereof to impart the desired result. Preferably, the ultraviolet stabilizer and/or absorber is present in an amount up to about 10% by weight, and more preferably about 1 to about 5%, based on the total weight of the ceramer composition solids. It should be understood that combinations of different ultraviolet stabilizers and absorbers can be used if desired.

An ozone stabilizer protects against degradation resulting from reaction with ozone. Examples of ozone stabilizers include, but are not limited to, hindered amines such as that available under the trade designation “IRGANOX 1010” from Ciba-Geigy and phenothiazine commercially available from Aldrich Chemical Company, Inc., Milwaukee, Wis. The ceramer composition can include an amount of an ozone stabilizer to impart the desired result. Preferably, the ozone stabilizer is present in an amount up to about 1% by weight, more preferably from about 0.1 to about 1.0%, and most preferably from about 0.3 to about 0.5%, based on the total weight of the ceramer composition solids. It should be understood that combinations of different ozone stabilizers can be used if desired.

A thermal stabilizer/antioxidant reduces the amount of yellowing as a result of weathering. Examples of such materials include, but are not limited to, low melting hindered phenols and triesters. Specific examples include 2,6-di-tert-butyl-4-methylphenol, commercially available under the trade designation “ULTRANOX 226” from Borg Warner Chemicals, Inc., Parkersburg, N.Y.; octadecyl 3,5-di-tert-butyl-4-hydroxyhydroxcinnamate, commercially available under the trade designations “ISONOX 132” antioxidant from Schenectady Chemicals, Inc., Schenectady, N.Y.; or “VANOX 1320” commercially available from Vanderbilt Co., Inc., Norwalk, Conn. The ceramer composition can include an amount of the thermal stabilizer/antioxidant to impart the desired result. Preferably, the thermal stabilizer/antioxidant is present in an amount up to about 3% by weight, and more preferably about 0.5-1%, based on the total weight of the ceramer composition solids. It should be understood that combinations of different thermal stabilizers/antioxidants can be used if desired.

### EXAMPLES

The following examples further illustrate the invention without the intention however to limit the invention thereto. All parts are by weight unless indicated otherwise.

1. Abbreviations

APTMS: aminopropyl trimethoxysilane
BDDA: 1,4-butanediol diacrylate
Des N3300: Desmodur™ N3300: HMDI trimer (triisocyanurate) from Bayer/Lanxess AG
Des N100: Desmodur™ N100: Hexamethylene diisocyanate biuret available from Bayer/Lanxess AG EG.: ethyleneglycol
HDDA: hexanedioldiacrylate
2HEA: 2-hydroxyethyl acrylate
2HEMA: 2-hydroxyethyl methacrylate
IPDI: isophorone diisocyanate
MeFBSE: N-methyl perfluorobutyl sulfonamido ethanol
MEHQ: methyl hydroquinone
MMA: methyl methacrylate
SR399: dipentaerythritol pentaacrylate from Sartomer, Cray Valley
SR444: pentaerythritol triacrylate from Sartomer, Cray Valley
Tolonate HDB: HMDI biuret from Rhodia (analog for DesN100)
   2. Synthesis of Intermediates

### Synthesis of (HFPO)-alc: F(CF(CF₃)CF₂O)_{6.85} CF(CF₃)C(O)NHCH₂CH₂OH (HFPO)-alc was prepared from the corresponding (HFPO)-ester: F(CF(CF₃)CF₂O)_{6.85}CF(CF₃)COOCH₃.

A 1 liter 3-necked reaction flask was equipped with a stirrer, a condenser, a dropping funnel, a heating mantle and a thermometer. The flask was charged with 1000 g (HFPO)-ester. The mixture was heated to 40° C. and 43.4 g ethanolamine was added via the dropping funnel, over a period of 30 minutes. The reaction mixture was kept at 65° C. during 3 hours. FTIR analysis indicated complete conversion. The end product was purified as follows: 500 ml ethyl acetate were added and the organic solution was washed with 200 ml HCL (1N), followed by 2 washings with 200 ml brine. The organic phase was dried over MgSO₄. Ethyl acetate was evaporated with water jet vacuum, using a Büchi rotary evaporator. The product was dried at 50° C. during 5 hours, using oil pump vacuum (<1 mbar). An alternative purification step included evaporation of methanol, formed during reaction, via water jet vacuum, using a Büchi rotary evaporator (up to 75° C.=<100 mm Hg). Residual methanol was further removed with oil pump vacuum (up to 80° C.,=<10 mbar). The (HFPO)-alc obtained, was a yellow coloured oil. The structure was confirmed by means of NMR.

Synthesis of MeFBSEA/HSCH₂CH₂OH (molar ratio 4/1): FC-oligom

A 3 liter glass reactor equipped with mechanical stirrer, 2 reflux condensers, heating mantle and vacuo inlet was charged with 1315.2 g MeFBSEA (3.2 eq.) and 918.4 g ethylacetate. After heating to 40° C. 62.4 g 2-mercapto-ethanol (0.8 eq.) was added to the clear monomer solution. A nitrogen atmosphere was applied by pulling vacuum with a waterjet and breaking the vacuum with nitrogen atmosphere (procedure repeated 4 times). At this point 2.76 g ABIN (2,2′-azobisisobutyronitrile; 0.2% on solids) was added. The reaction mixture was gradually heated to 70° C., at which point a vigorous exothermal reaction occurred with refluxing ethylacetate. The reaction was continued at 80° C. reflux temperature for 2 hrs, resulting in full monomer conversion as indicated via gas chromatography. The resulting oligomer solution was poured in a glass recipient and dried overnight at 65° C. in a forced air oven.

3. Examples

### Examples 1 to 7

In examples 1 to 7, urethane based fluorinated monomers were prepared according to the general procedure as given for example 1: MeFBSE/DESN100/2HEA 1/1/2 (molar ratio) in BDDA.

A 250 g polymerization bottle was charged with 17.9 g MeFBSE (50 meq.), 28.7 g Desmodur N100 (150 meq.), 11.6 g 2HEA (100 meq.), 12 mg MEHQ (200 ppm), 12 mg phenothiazine (200 ppm), 58.1 g BDDA and 29 mg DBTDL (0.05% on solids). The mixture was shaken until a homogeneous solution was obtained and subsequently placed in a preheated Launder-o-meter at 65° C. for 6 hours. FTIR analysis showed complete conversion. The reaction product was obtained as a clear semi-viscous 50% monomer solution. Examples 2 to 7 were prepared according to the same procedure. The composition of the examples and the appearance of the liquid reaction products are given in table 1.

TABLE 1
Composition of examples 1 to 7

| | | | Reactive | Conc. | Appearance |
|---|---|---|---|---|---|
| Ex | Composition | Molar ratio | diluent | % | liquid |
| 1 | MeFBSE/DesN100/2HEA | 1/1/2 | BDDA | 50 | Clear, semi- |
| | | | | | viscous |
| 2 | MeFBSE/DesN3300/EG/2HEA | 1/1/0.04/1.92 | BDDA | 75 | Clear, semi- |
| | | | | | viscous |
| 3 | (HPFO)-alc/IPDI/2HEMA | 1/1/2 | MMA | 75 | Clear, semi- |
| | | | | | viscous |
| 4 | (HPFO)-alc/IPDI/2HEMA | 1/1/2 | MMA | 85 | Clear, semi- |
| | | | | | viscous |
| 5 | (HPFO)-alc/DesN3300/2HEMA | 1/1/2 | MMA | 85 | hazy |
| 6 | (HPFO)- | 1/1/1.75/0.25 | MMA | 75 | hazy |
| | alc/DesN3300/2HEMA/APTMS | | | | |
| 7 | MeFBSE/DesN3300/2HEMA | 1/1/2 | MMA | 75 | Clear viscous |

### Examples 8 to 18 and Comparative Example C-1

In examples 8 to 18, urethane based fluorinated monomers were prepared according to the general procedure as given for example 8: FC-oligom/IPDI/2HEMA (1/1/1) in MMA.

Following ingredients were charged sequentially in a 100 ml polymerization bottle: 17.2 g dried FC-oligom solids (0.01 eq.), 2.2 g IPDI (0.02 eq.), 1.3 g 2HEMA (0.01 eq.), 1 mg MEHQ, 1 mg phenothiazine, 6.9 g MMA and 10 mg stannous octanoate catalyst. The polymerization bottle was sealed and run in a launder-o-meter, preheated to 75° C. After reacting for 3 hours the reaction was completed, as indicated by infra-red spectroscopy.

A clear yellowish viscous liquid, containing 75% urethane based fluorinated monomer in reactive diluent was obtained. Examples 9 to 18 were prepared according to the same procedure. The composition of the examples and the appearance of the liquid reaction products are given in table 2.

### Comparative Example C-1: (HFPO)-alc/IPDI/2HEMA (1/1/1) was made as follows:

A 100 ml reaction flask with magnetic stirring bar was charged with 12.6 g (HFPO)-alc (10 meq.), 2.2 g IPDI (20 meq.), 1.3 g 2HEMA (10 meq.), 3 mg MEHQ (200 ppm), 3 mg phenothiazine (200 ppm) and 8 mg stannous octanoate (0.05% on solids) respectively. The mixture was stirred and heated on an oil bath for 2 hours at 75° C. FTIR analysis showed complete conversion. The obtained reaction product was a clear homogeneous, but very viscous paste at 75° C., which solidified to a sticky wax at room temperature.

TABLE 2
Composition and appearance of examples 8 to 18

| | | | Reactive | Conc | Appearance |
|---|---|---|---|---|---|
| Ex | Composition | Molar ratio | diluent | % | liquid |
| 8 | FC-oligom/IPDI/2HEMA | 1/1/1 | MMA | 75 | Clear viscous |
| 9 | FC-oligom/DesN3300/2HEMA | 1/1/2 | MMA | 75 | Clear viscous |
| 10 | (HFPO)-alc/FC- | 0.75/0.75/1/1.5 | MMA | 85 | Hazy viscous |
| | oligom/DesN3300/2HEMA | | | | |
| 11 | (HFPO)-alc/FC- | 0.75/0.75/1/1.5 | MMA | 85 | Hazy viscous |
| | oligom/DesN3300/2HEA | | | | |
| 12 | (HFPO)-alc/FC- | 0.5/0.5/1/2 | MMA | 85 | Hazy viscous |
| | oligom/DesN3300/2HEMA | | | | |
| 13 | (HFPO)-alc/FC- | 0.5/0.5/1/2 | MMA | 85 | Hazy viscous |
| | oligom/DesN3300/2HEA | | | | |
| 14 | FC-oligom/DesN3300/2HEMA | 1/1/2 | MMA | 85 | Clear viscous |
| 15 | FC-oligom/DesN3300/2HEA | 1/1/2 | MMA | 85 | Clear viscous |
| 16 | FC-oligom/DesN100/2HEMA | 1/1/2 | MMA | 85 | Clear viscous |
| 17 | FC-oligom/DesN100/2HEA | 1/1/2 | MMA | 85 | Clear viscous |
| 18 | FC-oligom/Tolonate | 1/1/2 | MMA | 75 | Clear viscous |
| | HDB/2HEMA | | | | |

### Examples 19 to 24

Examples 19 to 24 were made essentially according to the procedure as given for example 19: (HFPO)-alc/Tolonate HDB/SR444 (0.45/1/2.55) in MMA.

A 1 liter round bottom 3-neck reaction flask equipped with a heating mantle, mechanical stirrer, reflux condenser, thermometer and CaCl₂ tube was charged with 94.3 g (HFPO)-alc (0.075 eq.), 95.5g Tolonate HDB (0.5 eq.), 0.202 g 2,6 di t.butyl 4-methyl phenol, 269.5 g MMA and 0.202 g DBTDL respectively. After heating the reaction mixture for 1 hour at 75° C., 214.4 g SR444 (0.425 eq.) were added and the reaction continued for 3 hours. FTIR analysis indicated complete conversion. The reaction product obtained was a clear semi-viscous 60% solution in reactive diluent.

Examples 20 to 24 were made essentially according to the same procedure except that in example 20, 0.1% DBTDL was used instead of 0.05%. The composition of the urethane based fluorinated monomers and the appearance of the liquid reaction mixture is given in table 3.

TABLE 3
Composition of examples 19-24

| | | | Reactive | Conc. | Appearance |
|---|---|---|---|---|---|
| Ex | Composition | Molar ratio | diluent | % | liquid |
| 19 | (HFPO)-alc/Tolonate | 0.45/1/2.55 | MMA | 60 | Clear, semi- |
| | HDB/SR444 | | | | viscous |
| 20 | (HFPO)-alc/Tolonate | 0.45/1/2.55 | MMA | 70 | Clear, semi- |
| | HDB/SR444 | | | | viscous |
| 21 | (HFPO)-alc/Tolonate | 0.45/1/2.55 | MMA | 50 | Clear, non- |
| | HDB/SR444 | | | | viscous |
| 22 | (HFPO)-alc/Jeffamine | 0.45/0.3/1/2.25 | MMA | 70 | Clear, viscous |
| | M600/Tolonate HDB/SR444 | | | | |
| 23 | (HFPO)-alc/Jeffamine | 0.45/0.3/1/2.25 | MMA | 75 | Slightly hazy |
| | M600/Tolonate HDB/SR444 | | | | viscous |
| 24 | (HFPO)-alc/Jeffamine | 0.45/0.3/1/2.25 | MMA | 60 | Clear, semi- |
| | M600/Tolonate HDB/SR444 | | | | viscous |

### Example 25

In example 25 a urethane based fluorinated monomer with composition MeFBSE/IPDI/SR399 0.3/0.3/1 (molar ratio) in HDDA was made as follows:

A round bottom reaction flask equipped with a mechanical stirrer was charged with 10 g MeFBSE (0.03 eq.), 17.45 g HDDA, 6.84 g IPDI (0.06 eq.) and one drop of tin ethyl hexanoate. After heating the reaction mixture for about 4 hours at 40° C., the mixture was heated to 60° C. and 52.94 g SR399 (0.1 eq.) was added. The reaction mixture was heated at 80° C. during 2 hours. FTIR analysis indicated complete conversion. The reaction product obtained was a hazy 37% solids solution in reactive diluent.

Various modifications and alterations to this invention will become apparent to those skilled in the art without departing from the scope and spirit of this invention.

1. Method of preparing urethane based fluorinated monomers comprising (i) reacting a fluorinated alcohol and an isocyanate functional non-fluorinated monomer or (ii) reacting in one or two steps a fluorinated alcohol, a polyisocyanate and an isocyanate reactive non-fluorinated monomer, said reactions (i) and (ii) being carried out in the presence of one or more reactive diluents, said reactive diluents having an ethylenically unsaturated group and being free of isocyanate reactive groups.

2. Method according to claim 1 wherein the isocyanate functional non-fluorinated monomer is selected from the group of isocyanate functional non-fluorinated acrylate or methacrylate monomers.

3. Method according to claim 1 wherein said reactions are carried out in absence of a solvent or substantially in absence of a solvent.

4. Method according to claim 1 wherein said fluorinated alcohol is selected from a monofunctional fluorinated alkanol having between 3 and 12 carbon atoms, a perfluoropolyether compound having one or more perfluorinated polyether groups and one or more hydroxyl groups, or an oligomeric fluorinated alcohol of the formula:
M^{f}ₘM^{h}ₙ-Q³-(OH)_{c}
wherein c is 1 or 2, M^{f}ₘM^{h}ₙ represents a fluorinated oligomer comprising m units derived from a fluorinated monomer and n units derived from a non-fluorinated monomer m represents a value of 2 to 40, n is 0 to 20, and -Q³-(OH)_{c} together represents the organic residue obtained by removing a hydrogen atom from a chain transfer agent that is functionalized with one or two hydroxy groups.

5. Method according to claim 1 wherein said reactive diluent is present in an amount of at least 10% based on the total weight of the reactive diluent and reactants.

6. Method according to claim 1 wherein the reactive diluent is liquid at a temperature of about 20° C.

7. Method according to claim 6 wherein said reactive diluent is selected from monomers having one or more acrylate or methacrylate groups, monomers having one or more vinyl ether groups and N-vinyl amides.

8. Method according to claim 1 wherein isocyanate reactive non-fluorinated monomer comprises a hydroxyl group.

9. Method according to claim 1 wherein said polyisocyanate is selected from one or more aliphatic isocyanates having 2, 3, or 4 isocyanate groups, one or more aromatic isocyanates having 2, 3, or 4 isocyanate groups and mixtures thereof.

10. Method according to claim 1 wherein said two-step reaction of said fluorinated alcohol, a polyisocyanate and an isocyanate reactive non-fluorinated monomer is carried out by reacting in a first step said fluorinated alcohol and said polyisocyanate in a ratio such that a resulting reaction product has one or more isocyanate groups and in a second step reacting the resulting reaction product of the first step with said isocyanate reactive non-fluorinated monomer.
